(19) United States
(12) Patent Application Publication
(10) Pub. No.: US 2024/0273379 A1
(43) Pub. Date: Aug. 15, 2024

(54) EFFICIENT RE-CLUSTERING FOR SECURE BYZANTINE-ROBUST FEDERATED LEARNING

(71) Applicant: Dell Products L.P., Round Rock, TX (US)

(72) Inventors: Pablo Nascimento da Silva, Niterói (BR); Maira Beatriz Hernandez Moran, Rio de Janeiro (BR); Paulo Abelha Ferreira, Rio de Janeiro (BR)

(21) Appl. No.: 18/168,974

(22) Filed: Feb. 14, 2023

(51) Int. Cl. G06N 3/098; G06F 16/28

(52) U.S. Cl. CPC G06N 3/098; G06F 16/285

(57) ABSTRACT

Efficient clustering in federated learning is disclosed. The number of clustering rounds performed in federated learning can be dynamically controlled by checking for convergence. After a warm-up operation, convergence is checked by comparing the gradients of a current round to gradients from a previous round. When a difference is withing a threshold distance, convergence is determined and the clustering operation is stopped. Federated learning continues based on the convergence obtained when the clustering operation was stopped.

### FIELD OF THE INVENTION

Embodiments of the present invention generally relate to federated machine learning. More particularly, at least some embodiments of the invention relate to systems, hardware, software, computer-readable media, and methods for clustering operations in federated learning.

### BACKGROUND

Federated learning, in general, is a technique whose objective is to achieve a goal in a distributed manner. In the context of federated machine learning, multiple nodes may use local data to each train a local model. Each of the nodes may transmit learning to a central node. The central node is configured to incorporate updates from the nodes into a global model. The central node may generate a global update that can be returned and incorporated to the local models at the nodes. This process can be repeated, for example, until convergence is achieved.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of federated learning in the context of machine learning models and federated machine learning.

FIG. 2 discloses aspects of clustering in federated learning;

FIG. 3 discloses aspects of a gain achieved by a convergence check operation, which limits or reduces a number of clustering rounds performed in federated learning;

FIG. 4A discloses aspects of a warm-up operation in federated learning;

FIG. 4B discloses aspects of a federated learning operation that includes a convergence check operation;

FIGS. 5A, 5B, and 5C disclose aspects of determining whether convergence has occurred such that subsequent clustering operations can be avoided;

FIG. 6 discloses aspects of a computing device, system, or entity; and

FIG. 7 discloses aspects of a SHARE (Secure Hierarchical Robust Aggregation) protocol.

### DETAILED DESCRIPTION OF SOME EXAMPLE EMBODIMENTS

Embodiments of the present invention generally relate to federated learning in the context of machine learning and machine learning models. More particularly, at least some embodiments of the invention relate to systems, hardware, software, computer-readable media, and methods for protecting federated learning processes from malicious attacks and for reducing processing requirements related to federated learning, which may include the processing and resource requirements of clustering operations.

By way of example, federated learning is a distributed framework for machine learning where nodes (or clients operating on nodes) jointly train a model without sharing their local or individual data with other nodes or with the central node. This is beneficial for entities that may provide or that want to participate in private distributed machine learning. In this type of federated learning, machine learning models are distributed to nodes (e.g., in one or more edge environments) where data may be kept local or private for various reasons such as compliance requirements, cost concerns, or strategic reasons.

Federated learning, in the context of machine learning scenarios, provides strong privacy assurances at least because the local data is not viewed globally. In federated machine learning, machine learning models distributed to each of the nodes and are trained locally at the nodes using local data. Local updates (e.g., updated gradients) learned or generated at a local model are sent to a global model being trained or operated at a central node. The central node then incorporates updates from multiple local models into the global model and returns a global update back to all of the nodes that can be incorporated into the local models. This process can be repeated until the model converges.

However, federated machine learning may be subject to attacks such as Byzantine attacks. In a Byzantine attack, a client operating at a node or the node itself is compromised. The compromised node can disrupt the coordination between other nodes and the central node and can disrupt, distort, or compromise the model updates transmitted to the central node. This is typically performed by modifying the gradient. Sending a compromised or incorrect gradient can disrupt model training and convergence.

More specifically, one objective of a Byzantine attack is to prevent the global model from converging correctly. In a Byzantine attack, an attacker may compromise a node or a client operating on the node. The compromised node may send compromised updates to the central node. These updates interfere or prevent the global model from being trained properly and may prevent convergence of the global model.

The attack is performed mainly by manipulating the compromised node to send defective updates to the server to introduce incorrect bias in the aggregation process. A malicious client can induce the aggregation rule result (Fₗᵢₙ) to yield a constant value T. Fₗᵢₙ may be defined as Fₗᵢₙ(δ₁, . . . , δₘ)=Σᵤ αᵤδᵤ, where each αᵤ are non-zero scalars. If the Byzantine client sends δₘ=(1/αₘ)*T−Σ^{m-1}ᵤ₌₁(αᵤ/αₘ)*δᵤ, then Fₗᵢₙ=T.

If the malicious node could access the updates sent by other nodes, the attack would be immediate. However, this is not realistic because many federated learning configurations implement protocols to ensure privacy, including protecting the updates from undesired access.

However, the malicious node may estimate the updates of other clients or their sum. For example, when the training process is advanced, the global model is close to convergence. In this scenario, the updates sent by the clients in consecutive rounds are very similar. This allows the malicious client to estimate the sum of the updates of other clients from a previous round by subtracting its own update from the global model. Based on this information, the malicious client tries to replace or adversely impact the global model. This is achieved by creating a special local update that nullifies the updates of other clients while boosting the update of the malicious client.

SHARE (Secure Hierarchical Robust Aggregation) is a framework that incorporates defenses against Byzantine attacks, while enhancing privacy aspects. The SHARE framework may allocate clients in clusters randomly. Clients in each cluster mask their own updates using pairwise secret keys shared between them. This enhances the privacy of the clients and their individual updates. The server learns just their mean. Next, the secure cluster averages are filtered through robust aggregation (ex.: median, Zeno, etc.) in order to eliminate clusters with Byzantine clients, according to their updates. These actions are repeated several times, and in each global epoch the clients are re-clustered randomly. One of the main limitations of this framework is the communications cost due to the key exchange sharing.

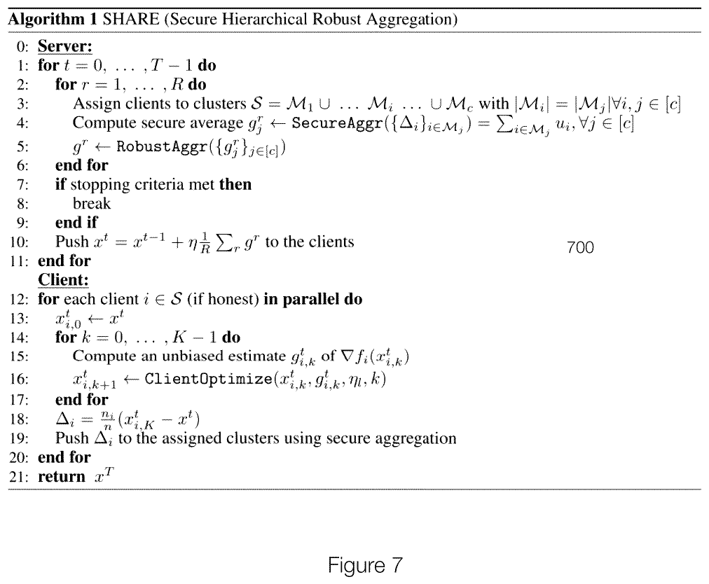

More specifically, the SHARE protocol runs on top of a federated learning system and, assuming that there is clustering of clients and that secure aggregation is performed at each cluster, generates one (summed) gradient gⱼ^{r} per cluster j and per re-clustering round r. SHARE runs a loop of R re-clusterings and at each re-clustering, SHARE generates an aggregated g^{r} by performing robust aggregation with all the gⱼ^{r} for the current re-clustering round. After R re-clustering rounds, a list of size R containing different aggregated gradients g^{r} is obtained. SHARE computes a central gradient including a mean overall g^{r}. FIG. 7 discloses aspects of a SHARE protocol. The SHARE protocol 700 may include secure aggregation and robust aggregation. This is described in Velicheti, Raj Kiriti, Derek Xia, and Oluwasamni Koyejo. “SecureByzantine-Robust Distributed Learning via Clustering” arXiv:2110.02940 (2021), which is incorporated by reference in its entirety.

Embodiments of the invention relate to a defense protocol to identify the compromised client or node (the Byzantine attacker) while guaranteeing privacy as much as possible. The ability to identify the attacker (e.g., the compromised client) is distinct from a federated learning system that is resilient to such attacks.

To enhance privacy, embodiments of the invention may organize the nodes (or clients) into clusters. Each cluster includes a subset of the nodes. This allows machine learning model updates to be aggregated as cluster updates prior to being transmitted to a central node. In one example, the individual updates are aggregated using an aggregation process, such as taking a median value per dimension from all gradient vectors. This may be repeated a given number of times and the mean of all robustly aggregated vectors is provided to the central node.

More specifically, federating learning includes clustering steps in which the clients are grouped into clusters in order to inform composed updates for each cluster instead of individual client updates. This improves privacy. From a general perspective, the cluster sizes can affect the privacy and robustness of the federated learning system.

Each cluster sends updates composed of the combination of the local updates of each of the cluster clients. In clusters with few nodes, each node update has a larger impact on the cluster updates. Consequently, the cluster update in these small clusters reveals more information about each node, consisting of a privacy threat. On the other hand, larger clusters present a higher probability of containing a compromised (e.g., Byzantine) node. In this sense, the cluster size can be considered a trade-off in this federated learning configuration because its value can affect both privacy and robustness.

Clustering operations may be performed multiple times as the model progresses toward convergence. Clustering can be used to identify a suspect client that may be representative of a Byzantine attack. This is described in U.S. application Ser. No. 18/045,527 filed Oct. 11, 2022, which is incorporated by reference in its entirety.

Embodiments of the invention relate to reducing the number of clustering rounds performed in federated learning to increase the efficiency and performance of the model being trained while keeping the model secure from attacks such as Byzantine attacks. In federated learning, multiple clustering cycles or rounds may be performed. Each round may include clustering N nodes into c different clusters. During this process, secure aggregation and robust aggregation are applied in each cluster. This allows a mean of each gradient to be stored in a tensor for each cluster.

The number of clustering rounds, however, has a computational cost in terms of resources and time. Embodiments of the invention relate to stopping the clustering rounds early rather than simply performing a predetermined number of clustering rounds. In other words, the number of clustering rounds may not be determined in advance and may be determined dynamically.

The decision to stop clustering may depend on a stop criterion. The stop criterion may be defined, in one example, as a difference between the centroid of a set of gradients G and a centroid of gradients in G with the addition of a new gradient. In other words, the set of gradients can be plotted for each round and a centroid can be calculated for the plotted gradients. The different between the centroids for round (r) and round (r−1) can be used to determine that the model is converging or is sufficient converged. When this difference (e.g., a distance) is less than a pre-defined or predetermined threshold (c), the clustering results are deemed to be stable and subsequent clustering steps are not performed. This allows the number of clustering rounds to be reduced.

Thus, embodiments of the invention relate to monitoring the gradients to avoid a Byzantine attack, stopping the clustering process, and/or adjusting the number of clusterings on-the-fly according to how the gradients are converging.

In federated learning, one objective is to train, in an iterative manner, a model based on the data processed at individual nodes. The nodes, for example, may be edge nodes that participate in federated learning with a central node at, for example, a datacenter. In each global iteration, sampled nodes (not all nodes are required to participate in the federated learning) may run a stochastic gradient descent using local data to obtain local model updates. These local model updates are aggregated at the central note to compute a global model update that can be returned to and incorporated into the local models.

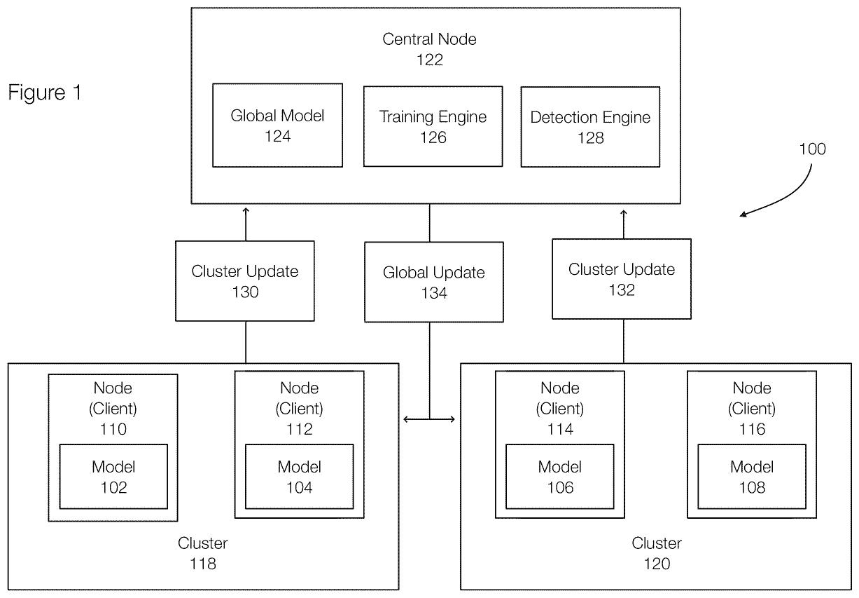

FIG. 1 discloses aspects of federated learning in the context of machine learning models and federated machine learning. FIG. 1 illustrates nodes 110, 112, 114, and 116, which include respectively, models 102, 104, 106, and 108. The nodes 110, 112, 114, and 116 may include or are associated with processors, memory, networking hardware, or the like and may by physical machines, virtual machines, containers, or the like. The nodes 110, 112, 114, and 116 are also examples of clients of a central node 122.

In this example, the nodes 110 and 112 are in a cluster 118 and the nodes 114 and 116 are in a cluster 120. The nodes 110, 112, 114, and 116 may have clients operating thereon. The node 110 may train the model 102 using data collected/generated at the node 110. In other words, the data used to train the model 102 is distinct from data used to train the other models 104, 106, and 108. Further, data local to the node 110 is not shared with the other nodes that participate in the federated learning system 100.

As the models 102, 104, 106, and 108 are trained, updates may be generated or identified by each of the nodes or clients. The cluster 118 may provide a cluster update 130 to the central node 122. The cluster update 130 includes updates from the model 102 and the model 104. The cluster update 130 may be generated using secure and robust aggregation, such as may be obtained using a SHARE protocol. The cluster update 132 may be determined in a similar manner.

The training engine 126 of the central node 122 uses the cluster update 130 and 132 to train/update the global model 124. The training engine 126 may then generate a global update 134 that is distributed to the nodes 110, 112, 114, and 116 and used to update the models 102, 104, 106, and 108. This process may occur iteratively at least until, in one embodiment, the global model 124 converges. Once this occurs, the model is trained and may be used for inferences. Updates, however, may still be performed.

The clustering aspect of federated learning is a resource-consuming task. Clustering includes assigning each of the nodes in a federating learning environment to clusters, managing the resulting gradients from these nodes, securely aggregating the gradients, robustly aggregating the gradients, and the like.

Embodiments of the invention relate to a convergence check operation. In a convergence check operation, the convergence of the gradients is determined or checked. When the convergence is sufficient, the clustering operations can be terminated. Thus, the number of clustering rounds needed to successfully perform federated learning can be dynamically determined.

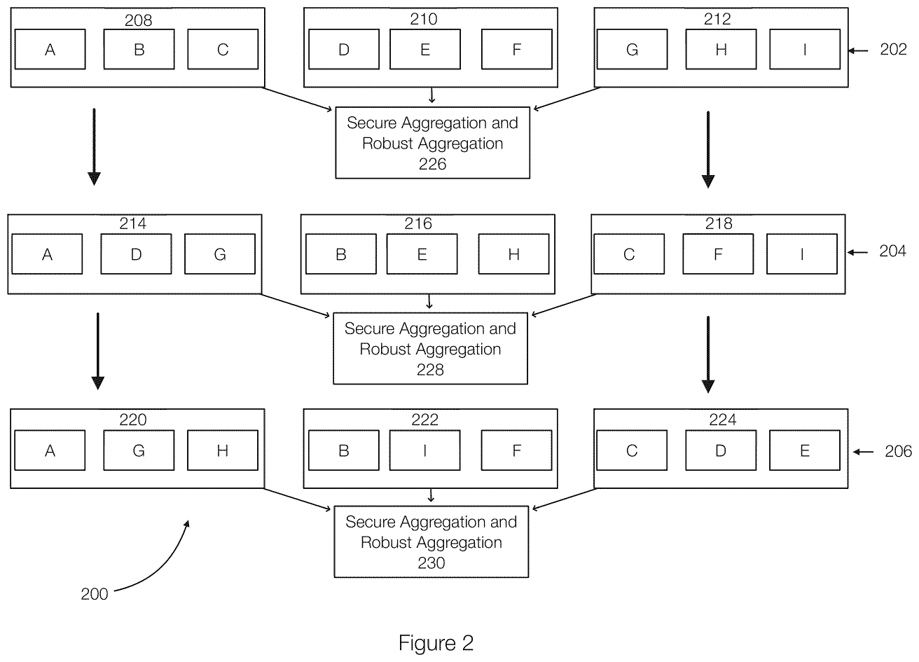

FIG. 2 discloses aspects of clustering. More specifically, FIG. 2 illustrates clustering cycles or rounds that may be performed in federated learning. FIG. 2 illustrates a federated learning environment 200 that includes multiple nodes, represented as nodes A, B, C, D, E, F, G, H, and I. Initially, the nodes are clustered at 202 into clusters 208, 210, and 212. The clusters 208, 210, and 212 include, respectively, nodes (A,B,C), (D,E,F), and (G,H,I). The gradients generated by the models operating at the nodes in these clusters 208, 210, and 212 are securely and robustly aggregated 226. After the gradients are securely and robustly aggregated, a final gradient (e.g., represented as a tensor) is generated and added to a list of gradient G.

Later in federated learning, another clustering round is performed, represented by the clustering at 204. Clustering (or re-clustering) allows the nodes to be placed into different clusters with different nodes. Thus, the clustering 204 results in clusters 214, 216, and 218 that include, respectively, nodes (A,D,G), (B,E,H), and (C,F,I). The gradients from the clusters 214, 216, and 218 are securely and robustly aggregated 228 and the gradients are updated as required.

Another clustering 206 may be performed. This assigns the nodes to different clusters again. The clustering 206 results in clusters 220, 222, and 224 that include, respectively, nodes (A,G,H), (B,I,F), and (C,D,E). The resulting gradients are securely and robustly aggregated 230 and the set of gradients G is updated as required.

Embodiments of the invention may perform, after each round, a convergence check operation. The convergence check operation evaluates how the gradients are converging. When the set of gradients G starts to converge or are going towards a convergency state, the clustering operations can be terminated. Thus, once the convergence check operation determines that convergence is sufficient, the process of clustering the nodes is stopped using this stop criterion.

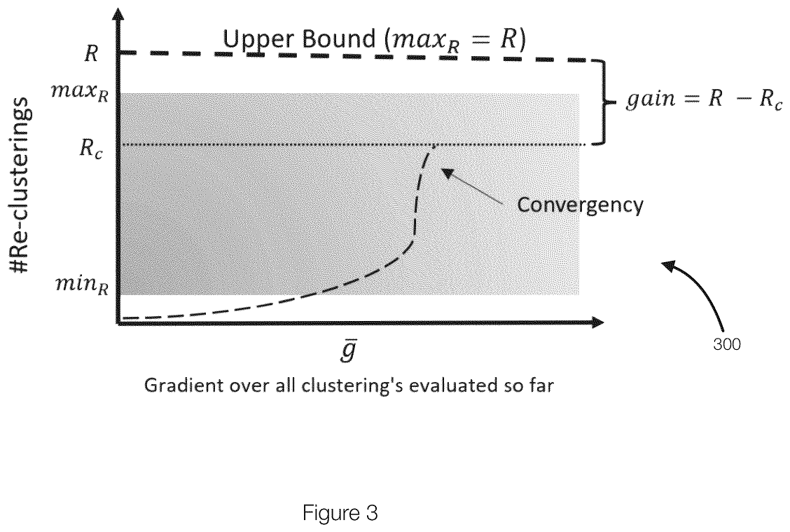

FIG. 3 discloses aspects of a gain obtained using a stop criterion to reduce the number of clustering rounds performed in federated learning. Decreasing the number of clustering rounds implies that the computational time needed to run or perform federated learning or federated training is reduced. The graph 300 in FIG. 3 illustrates an example of a total gain achieved by a convergence check operation. In this example, federated training may require max_{R} clustering rounds. In this example, R represents an upper limit on the number of clustering rounds. R and max values may be different.

Embodiments of the invention stop clustering when the gradients obtained by the clustering rounds already performed start to converge or are going towards a stable convergency state. This may be achieved after R_{C} clustering rounds have been performed. The gain, by way of example, is a difference between using R clustering rounds and R_{C} clustering rounds. The Round number R_{C} is determined when the gradients converge or stop changing more than a determined amount. Thus, gain=R−R_{C} as illustrated in the graph 300. This represents a reduction in computation time and represents less resources consumption.

Generally, embodiments of the invention monitor results of robustly aggregating the gradients to determine whether or not the clustering or re-clustering process can be stopped.

Prior to evaluating the robust aggregation results, the federated learning process may perform a warm-up operation. A warm-up operation is performed to ensure that the clustering or re-clustering operations are not terminated prematurely. In order to effectively determine whether the gradients are, in fact, converging, it is useful to obtain a sufficient amount of data.

In the warm-up operation, federated learning operations including clustering or re-clustering operations are performed for a pre-defined number (minᵣ) of rounds. The gradient determined from each of these warm-up rounds is added to a set of gradients G. The value of min can be predetermined (e.g., set by an expert).

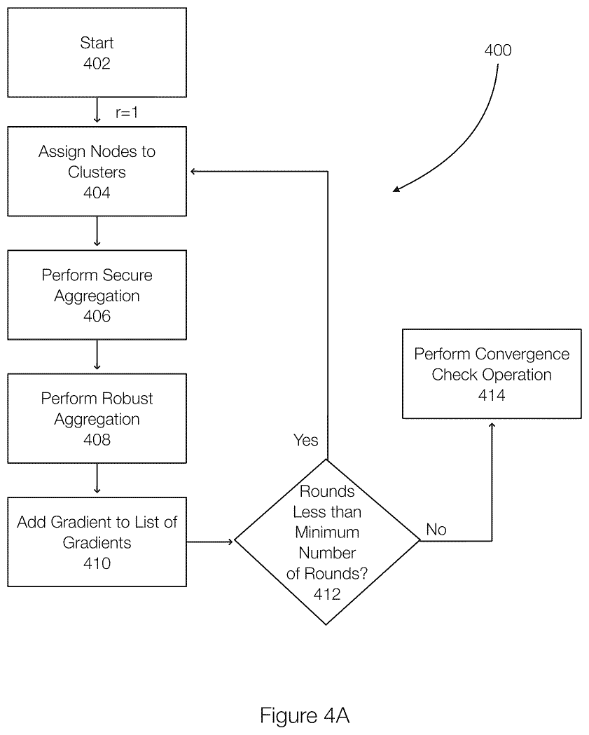

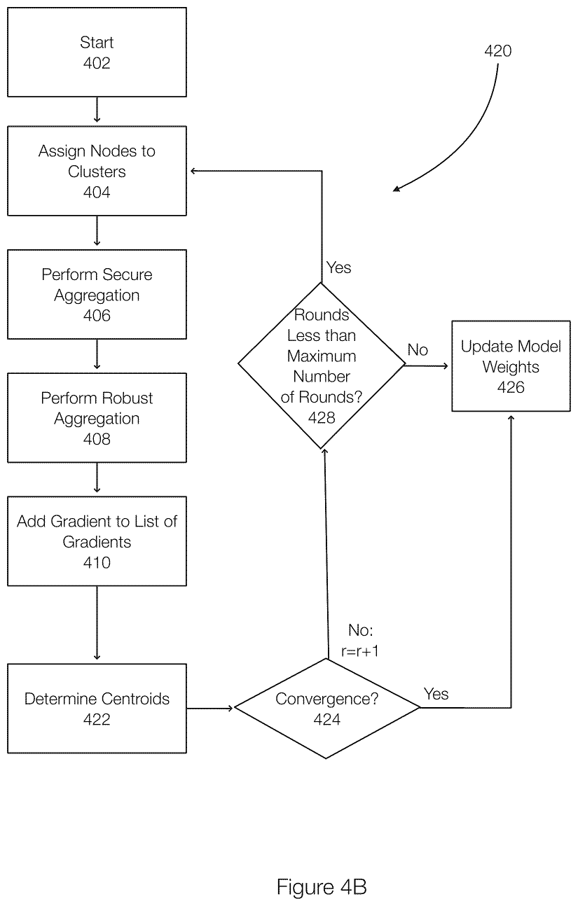

FIG. 4A discloses aspects of a warm-up operation. The warm-up operation is performed to ensure that the federated learning system does not stop the clustering or re-clustering operations prematurely. The method 400 starts 402 with r=1 (round 1). In the current round, nodes are assigned 404 to clusters as part of the clustering operations.

The gradients generated at the nodes in response to training the model locally at each of the nodes are securely aggregated 406. During secure aggregation, one summed gradient may be generated. Each of the nodes is able share a gradient (e.g., a sum) without revealing private values during secure aggregation 406. Secure aggregation enables a sum to be determined from distributed tensors (e.g., from the nodes in the cluster).

Next, robust aggregation is performed 408. Robust aggregation aggregates the gradients from the cluster or from the clusters. However, robust aggregation ensures that outliers or suspect gradients are excluded from the robust aggregation. Once the gradients have been robustly aggregated, a final gradient for the current round is generated and added to a list of gradients. Thus, the gradient g^{r} is added to the list of gradients G. If the current round number is less than the minimum number of rounds (r≤min_{T}) (Yes at 412), another clustering round is performed. In the next clustering round, the nodes are placed (re-clustered) into different clusters. If a sufficient number of rounds have been performed (N at 412) or the warm-up operation is completed, the convergence check operation is performed 414 or is introduced into the federated learning operations.

FIG. 4B discloses aspects of federated learning that includes a convergence check operation. The method 420 assumes that the warm-up operation has been completed. The method 420 uses the same round count r. In other words, after the warm-up operation is completed, the process continues to perform rounds that each include a clustering. Thus, if the warm-up operation required 5 rounds, the first round of the method 420 is round 6.

In the method 420 (as in the method 400), the nodes are assigned 404 to clusters, secure aggregation is performed 406, robust aggregation is performed 408, and the resulting gradient is added to the list of gradients.

The method 420 adds the convergence check operation. In one example, centroids are calculated 422 during the convergence check operation. More specifically, a centroid for the current list of gradients is calculated and a centroid for the previous round with the previous list of gradients is determined. This may be expressed as follows:

$${o}_{r - 1} ← c ( \{ G \} \{ {g}^{r} \} ) and {o}_{r} ← c ( \{ G \} ) .$$

After determining these centroids for rounds r and r−1 (oᵣ₋₁ and oᵣ), a distance between the two centroids is determined: d(oᵣ₋₁, oᵣ) and compared to a threshold (ε). When the distance is greater than a threshold (d(oᵣ₋₁, oᵣ)>ε), then convergence is not achieved or determined (N at 424) and r is increased (r=r+1). If the number of rounds is less than the maximum number of rounds (maxᵣ) (Y at 428), then another clustering round is performed. If the maximum number of clustering rounds has been performed (N at 418), then the model weights are updated 426.

If convergence is determined (d(oᵣ₋₁, oᵣ)<ε) (Yes at 424), the clustering rounds are stopped and the model weights are updated 426. When convergence is determined (Yes at 424), the current clustering round is the last clustering round for this portion of federated learning. This is round R_{C}, which is likely less than both round max_{R} and the round R. Thus, the gain of R−R_{C}=gain is achieved.

The method 420 illustrates that if the distance (e.g., a Euclidian distance or cosine similarity) between the two most recent centroids is less than a predetermined threshold, the method 420 determines that convergence has occurred and the process of performing another clustering round is stopped. In other words, as illustrated in FIG. 3, the number of rounds performed is R_{C} rather than R or max_{R} rounds. This achieves a gain at least in the sense that fewer rounds are performed, thereby saving computational time and resources.

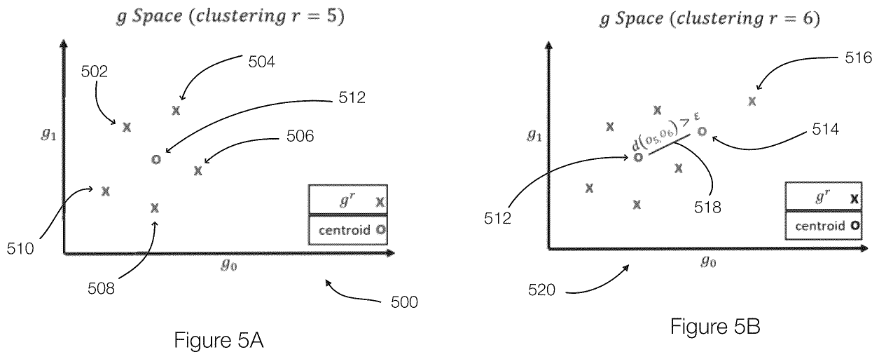

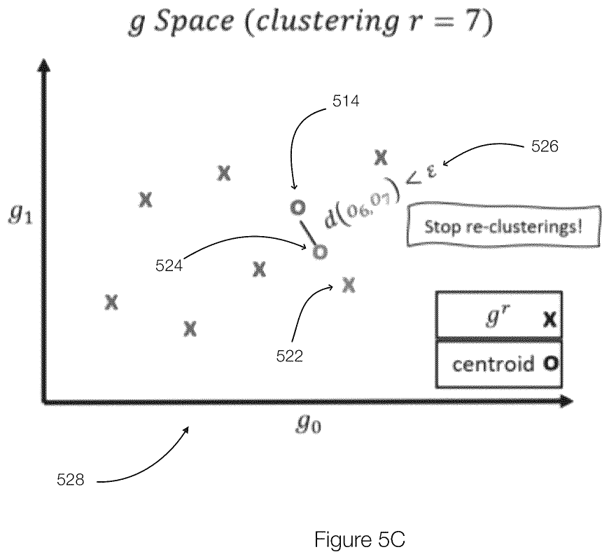

FIGS. 5A, 5B, and 5C disclose aspects of determining whether convergence has occurred during the federated learning operation or, more specifically, in the context of clustering rounds. Although gradients are often multi-dimensional, FIGS. 5A-5C illustrate a plot are illustrated as a 2D plot.

Figured 5A illustrates a plot of gradients and a centroid of the gradients after 5 clustering founds (r=5). After 5 rounds, the list of gradients G includes gradients g¹, g², g³, g⁴, and g⁵ have been determined. In one example, the first four rounds may be determined in the warm-up operation. A centroid 512 is determined for the list of gradients and plotted in the plot 500.

FIG. 5B illustrates a plot of gradients and centroids after 6 clustering rounds. In FIG. 5B, an additional gradient 516 (g⁶) has been determined and plotted in the plot 520. A new centroid (o₆) 514 is also determined for this clustering round. In this example, a distance 518 is determined between the centroid 512 (calculated in FIG. 5A) and the centroid 514 (calculated in FIG. 5B). If the distance is greater than a threshold ε, convergence is not determined and the clustering continues as long as the number of rounds is not greater than a maximum number of rounds. If the distance is less than the threshold, convergence is determined and the clustering or re-clustering is stopped.

FIG. 5C illustrates a plot of gradients and centroids after 7 clustering rounds. In this example, a gradient g⁷ 522 is added and plotted along with the gradients shown in FIGS. 5A and 5B. A new centroid 524 that accounts for the gradients (g¹⁻⁷) is calculated and determined. FIG. 5C illustrates a distance 526 between the current centroid 522 and the most recent centroid 514 (see FIG. 5B) from the previous clustering round is determined. As illustrated, the distance 526 is smaller than the distance 518. Further, the re-clustering operation is stopped as the distance 526 is below or less than a threshold value. When the distance 526 is below a threshold, the convergence check operation succeeds.

When the clustering or re-clustering operation is stopped based on the convergence check operation, the gradients in the list of gradients G are used to update the global model in the context of federated learning. In one example, the mean of the gradients in G is determined and a gradient descent method may be applied to update the global model in each federated learning round.

Embodiments of the invention may perform max rounds without achieving convergence of the centroids. In one example, the number of max rounds may be dynamically increased when the distance function is greater than the threshold. Thus, max_{R} may be changed dynamically based on the outcome of the convergence check operation. However, embodiments of the invention may not increase the max number of rounds to a value that is greater than an upper-bound limit of rounds (R).

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, clustering operations, convergence check operations, convergence related operations, aggregation operations, federated learning operations, or the like or combination thereof.

New and/or modified data collected and/or generated in connection with some embodiments, may be stored in a computing or storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform machine learning related operations.

Example cloud computing environments, which may or may not be public, include storage environments that may provide data protection functionality for one or more clients. Another example of a cloud computing environment is one in which processing, machine learning, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, system components such as databases, storage servers, storage volumes (LUNs), storage disks, nodes, central nodes, for example, may likewise take the form of software, physical machines, containers, or virtual machines (VMs), though no particular component implementation is required for any embodiment.

Example embodiments of the invention are applicable to any system capable of storing and handling various types of objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: performing a clustering operation in a round of federated learning, wherein nodes participating in the federated learning are grouped into clusters, determining a gradient for the clusters for the round, performing a convergence check operation, performing another round of clustering if the convergence check operation fails and stopping the clustering operation when the convergence check indicates that gradients from the nodes are converging, and updating a model with the gradients when the convergence check operation succeeds.

Embodiment 2. The method of embodiment 1, further comprising performing secure aggregation for the gradients.

Embodiment 3. The method of embodiment 1 and/or 2, further comprising performing robust aggregation for the gradients to generate a final gradient for the round.

Embodiment 4. The method of embodiment 1, 2, and/or 3, wherein the final gradient for the round is derived from a list of gradients.

Embodiment 5. The method of embodiment 1, 2, 3, and/or 4, wherein the convergence check operation includes determining a centroid for the list of gradients in the round and determining a second centroid corresponding to the list of gradients for a previous round.

Embodiment 6. The method of embodiment 1, 2, 3, 4, and/or 5, further comprising determining a distance between the centroid and the second centroid.

Embodiment 7. The method of embodiment 1, 2, 3, 4, 5, and/or 6, wherein the convergence check fails when the distance is greater than a threshold distance.

Embodiment 8. The method of embodiment 1, 2, 3, 4, 5, 6, and/or 7, wherein the convergence is determined when the distance is less than a threshold distance.

Embodiment 9. The method of embodiment 1, 2, 3, 4, 5, 6, 7, and/or 8, further comprising performing a warm-up operation that includes a minimum number of rounds, wherein the convergence check operation is performed after the minimum number of rounds have been completed.

Embodiment 10. The method of embodiment 1, 2, 3, 4, 5, 6, 7, 8, and/or 9, further comprising dynamically adjusting a maximum number of rounds when convergence fails after performing the maximum number of rounds, wherein the maximum number of rounds is less than or equal to an upper limit of rounds.

Embodiment 11. A system, comprising hardware and/or software, operable to perform any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

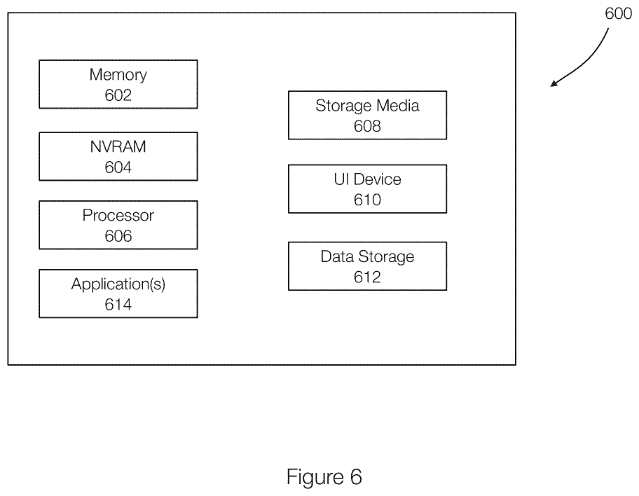

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent other computing systems such as edge systems, cloud-based systems, or the like or combinations thereof.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a clustering operation in a round of federated learning, wherein nodes participating in the federated learning are grouped into clusters;
determining a gradient for the clusters for the round;
performing a convergence check operation;
performing another round of clustering if the convergence check operation fails and stopping the clustering operation when the convergence check indicates that gradients from the nodes are converging; and
updating a model with the gradients when the convergence check operation succeeds.

2. The method of claim 1, further comprising performing secure aggregation for the gradients.

3. The method of claim 2, further comprising performing robust aggregation for the gradients to generate a final gradient for the round.

4. The method of claim 3, wherein the final gradient for the round is derived from a list of gradients.

5. The method of claim 4, wherein the convergence check operation includes determining a centroid for the list of gradients in the round and determining a second centroid corresponding to the list of gradients for a previous round.

6. The method of claim 5, further comprising determining a distance between the centroid and the second centroid.

7. The method of claim 6, wherein the convergence check fails when the distance is greater than a threshold distance.

8. The method of claim 6, wherein the convergence is determined when the distance is less than a threshold distance.

9. The method of claim 1, further comprising performing a warm-up operation that includes a minimum number of rounds, wherein the convergence check operation is performed after the minimum number of rounds have been completed.

10. The method of claim 1, further comprising dynamically adjusting a maximum number of rounds when convergence fails after performing the maximum number of rounds, wherein the maximum number of rounds is less than or equal to an upper limit of rounds.

11. A non-transitory storage medium having stored therein instructions that are executable by one or more hardware processors to perform operations comprising:
performing a clustering operation in a round of federated learning, wherein nodes participating in the federated learning are grouped into clusters;
determining a gradient for the clusters for the round;
performing a convergence check operation;
performing another round of clustering if the convergence check operation fails and stopping the clustering operation when the convergence check indicates that gradients from the nodes are converging; and
updating a model with the gradients when the convergence check operation succeeds.

12. The non-transitory storage medium of claim 11, further comprising performing secure aggregation for the gradients.

13. The non-transitory storage medium of claim 12, further comprising performing robust aggregation for the gradients to generate a final gradient for the round.

14. The non-transitory storage medium of claim 13, wherein the final gradient for the round is derived from a list of gradients.

15. The non-transitory storage medium of claim 14, wherein the convergence check operation includes determining a centroid for the list of gradients in the round and determining a second centroid corresponding to the list of gradients for a previous round.

16. The non-transitory storage medium of claim 15, further comprising determining a distance between the centroid and the second centroid.

17. The non-transitory storage medium of claim 16, wherein the convergence check fails when the distance is greater than a threshold distance.

18. The non-transitory storage medium of claim 16, wherein the convergence is determined when the distance is less than a threshold distance.

19. The non-transitory storage medium of claim 11, further comprising performing a warm-up operation that includes a minimum number of rounds, wherein the convergence check operation is performed after the minimum number of rounds have been completed.

20. The non-transitory storage medium of claim 11, further comprising dynamically adjusting a maximum number of rounds when convergence fails after performing the maximum number of rounds, wherein the maximum number of rounds is less than or equal to an upper limit of rounds.
